(19) United States
(12) Patent Application Publication
(10) Pub. No.: US 2006/0221935 A1
(43) Pub. Date: Oct. 5, 2006

(54) Method and apparatus for representing communication attributes

(76) Inventors: Daniel H. Wong, San Jose, CA (US); Lu Chang, Cupertino, CA (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/095,832

(22) Filed: Mar. 31, 2005

(51) Int. Cl. H04L 12/66

(52) U.S. Cl. 370/352

(57) ABSTRACT

A method and apparatus for visually representing characteristics of communication processed by a communication device (100) having at least one sensor (104) and a display device (122) are disclosed. When a call is engaged (402), the communication is monitored (404) by the sensor to generate a sensor signal (610). The sensor signal is correlated with an expression code (416) and stored (614) the memory (124) of the communication device (100). A visual representation (502) of an expression code is displayed (428) on the display device (122).

### FIELD OF THE INVENTION

The present invention relates generally to communication devices and more particularly to a method and device for summarizing and representing communication attributes within a communication device.

### BACKGROUND

Communication networks are used to transmit digital data both through wires and through radio frequency links. Examples of communication networks are cellular telephone networks, messaging networks, and Internet networks. Such networks include land lines, radio links and satellite links, and can be used for such purposes as cellular telephone systems, Internet systems, computer networks, messaging systems and other satellite systems, singularly or in combination.

A wide variety of handheld communication devices have been developed for use within various networks. Such handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Both wireless and wired communication technology has advanced to include the transfer of high content data. As an example, many mobile devices now include Internet access and/or multi-media content.

Some communication devices today are being configured to incorporate functions that PDAs historically maintained, such as calendaring, text messaging, and list development. Furthermore, some communication devices are equipped with cameras and instructions for transmitting pictures to other devices or over the Internet. Internet browsing and communication are also becoming commonplace in cellular devices such as cellular telephones. As semiconductor technology continues to improve, more communication features may be incorporated into increasingly smaller devices.

The above-described devices may be capable of providing to their user particular environmental information. For example, sensors may indicate the ambient temperature, humidity, the barometric pressure and the like.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a communication device including at least one sensor and electronic components in accordance with some embodiments of the invention;

FIG. 2 is an example flow chart of a process for a communication device in communication with a central unit to request and receive code and instructions to carry out methods in accordance with some embodiments of the invention;

FIG. 3 is an example of expression codes correlated with expressions and visual representations thereof in accordance with some embodiments of the invention;

FIG. 4 is an example of a flow chart of the sensors generating signals and the associated expression codes being stored in accordance with some embodiments of the invention;

FIG. 5 is an example of expression codes that may be provided in a file log on a display device in accordance with some embodiments of the invention; and

FIG. 6 is an example of flowchart of communication that may occur between two or more parties in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to summarizing and representing communication attributes within a communication device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of summarizing and representing communication attributes within a communication device described herein. The non-processor circuits may include, but are not limited to, a radio receiver, a radio transmitter, signal drivers, clock circuits, power source circuits, and user input devices. As such, these functions may be interpreted as steps of a method to perform summarizing and representing communication attributes within a communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Disclosed is a method and device for monitoring the attributes of communication expression with sensors, generating signals according to the communication expression, and correlating the signals with expression codes, or numerical or other representations. Sensors can be embedded into or attached to a communication device such as a mobile telephone. Sensors can detect touch, pressure, voice characteristics such as loudness, and motion. When a communication between the communication device and another device is engaged, the sensor readings are converted to numerical representations, i.e., expression or emotional codes that can be logged in a log file. The communication device can store, display and transmit the log. The second communication device can thereafter receive a copy of the log, or, alternatively, transmission of such information can be blocked at either device. Mapping the codes to visual, audio or other representations is further disclosed. In this way, visual representations of the expression sensed by one or more sensors during communication can be displayed on the device's display. Similarly, audible, haptic, olfactory, or other sensory representation of the expression may be presented within or annunciated by the device. Moreover, downloading the instructions and expression codes for the communication device to use, manipulate and customize is also described.

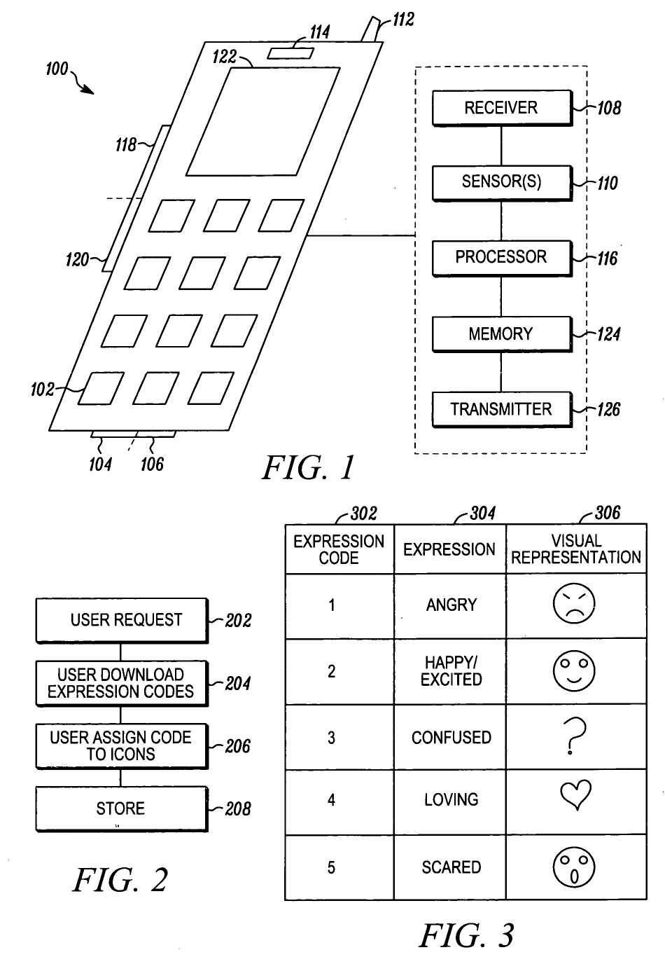

FIG. 1 depicts a communication device including at least one sensor and other electronic components. The communication device depicted is a cellular communication device, for example, a cellular telephone. It will be appreciated by those of ordinary skill in the art of the present invention is applicable to any electronic device configured as described herein.

A communication device 100 includes input components 102 for a user to configure and use the device. A microphone 104 and a sensor 106 provide audio input capabilities. In one embodiment, the microphone or mouth piece 104 further includes at least one sensor. Alternatively a voice sensor can be a separate component 106 from the mouth piece 104.

In general, the voice sensor 106 detects voice characteristics. Certain voice expressions can include increased or decreased volume. Other voice expressions can be classified as abrupt or smooth. In accordance with the present invention, voice characteristics can include any of those capable of being captured by voice sensor monitoring. The voice sensor 106 further can be configured to monitor tone of the user's voice, volume of the user's voice and any other voice characteristic or attribute. Noises other than a voice, such as ambient noise, can also be detected. For example, if traffic noise is detected, a processor correlates the noise signal to traffic noise. Later, the circumstances of a telephone call can be recalled.

Additionally, communication device 100 receives communications. As with the voice sensor, the receiver 108 can include sensing capabilities, or can be adapted to transmit signals to a sensor 110 separate from the receiver. An antenna 112 operates to transmit and receive communication signals. A speaker 114 for use during communication generates audible signals received via the antenna 112 or signals generated within the communication device 100. The speaker 114 also outputs audible signals generated by the communication device 100.

Whether an expression is generated by a user or the expression is received, the expression is monitored and sensed by at least one sensor within the communication device 100. As mentioned above, expression characteristics including voice loudness, pitch, ambient noise and duration can be sensed by the communication device 100. For example, loud shouting can be interpreted as an angry or stressful expression. Voice and ambient noise characteristics are processed by processor 116. The processor 116 of communication device 100 receives instructions to process sensor signals stored in memory 124 or alternatively includes hard-wired circuitry to process the sensor signals.

In accordance with the present invention, tactile sensors that provide haptic feedback can be incorporated into or on the communication device 100. For example, pressure, touch and/or heat sensors 118 and/or motion sensors 120 can be incorporated into the communication device 100. In FIG. 1 these sensors are depicted as one or two, but they can be separate or combined and placed in any location on the device. The sensitivity level of the sensors can vary according to the price of the device, and can also be configurable by the user. These sensors monitor expression characteristics of the user. Their signals indicate emotional or expression characteristics such as strength of grip on the device by the user's hand, or the heat generated by the user's hand. For example, the pressure sensors can be used to determine how tightly the user is squeezing the communication device 100. Tight grip signals from the sensor can be translated to an angry or stressful expression. For example, reduced heat or hand moisture may indicate a flight or fight condition of the user, indicating stress. Heart beats per minute or pulse may be monitored as well. Any expression, mood or emotion indicator can be sensed in accordance with the present invention.

The communication device 100, in one embodiment, is initially equipped with default mapping of one or more sensor readings to associated expression codes. Visual representations of the expression codes can thereafter be annunciated on a display device 122. Certain expression codes (i.e. 1-100) map to happy images, other expression codes 101-200 can map to sad images, and so on. A future upgrade to the device could supply a more finely tuned emotional representation, e.g. 1-10 can map to very happy, and 41-50 can map to somewhat happy. A default set of expression codes can be installed within the communication device 100 as purchased. Alternatively, a communication device 100 can be retrofitted to include expression code capability. The default set of expression codes can be replaced with a theme or a user-defined set of codes correlated to representations. The transmitter 126 can provide requests to a remote unit, described below, for codes in addition to default codes. The transmitter 126 further provides communication between the user and other communication devices.

FIG. 2 is a flow chart of a process for a communication device in communication with a central unit. The communication device can request and receive code and instructions to carry out methods described herein. The central unit can be, for example, a media gateway, or any other communication device, such as another electronic unit that communicates bundles of instructions and codes upon request or when unsolicited. The communication device can make a user request 202 of a central communication unit to download codes and/or instructions. The request is downloaded 204.

A user configures the visual or audible representations as he or she chooses at 206. A theme or set of themes may be chosen, for example. A theme can include characters from a particular movie or television show to represent various expressions. An animated sequence of facial expressions or actions, such as an animated sequence of a person laughing uncontrollably can be used. Also, a user can use customized images, such as a photo taken by a digital camera, for example, in the telephone. In any event, the instructions and/or codes are stored at step 208. It will be appreciated by those of ordinary skill in the art that the configuration step 206 is an optional step.

Expressions attributes have an associated numerical code, called an “expression code.” An expression code can be translated into a visual representation, an audible sound or other indicator including device vibrations. The representation can be annunciated in more than one way. For example, the audible representation can be voice, a noise, music or any other type of audible signal. The visual representation can be light, highlighting using color or white light, an image, an animated or motion picture sequence, avatars, a word in English or other language, a numerical representation and any other type of visual signal. The foregoing list is intended to cover examples of types of annunciation. As technology improves processes for annunciation, they will be included as well. For example, holograms, projections, and olfactory outputs may be possible annunciations in communication device that is not currently available, but are within the scope of this discussion.

The sensors provide signals that are converted to expression codes that can be numerical codes. For example the codes may range from 1-1000. Each sensor may need to be calibrated at a preliminary set-up step. The normal operating range of each sensor's output can be normalized to the range of sensor input to the communication device 100.

Three embodiments are described to save additional information along with the expression code. It will be apparent to anyone of ordinary skill in the art that expression codes can be accompanied by additional information. A numerical expression code along with a time stamp the first integer may represent the expression code. In addition the second integer may represent hour, minute, seconds of the current timestamp in the manner of 100, HHMMSS, for example. To save a numerical expression code with the duration of that expression in seconds, the code can further be accompanied by another integer. To save an offset from the start time, the numerical expression code may include another integer.

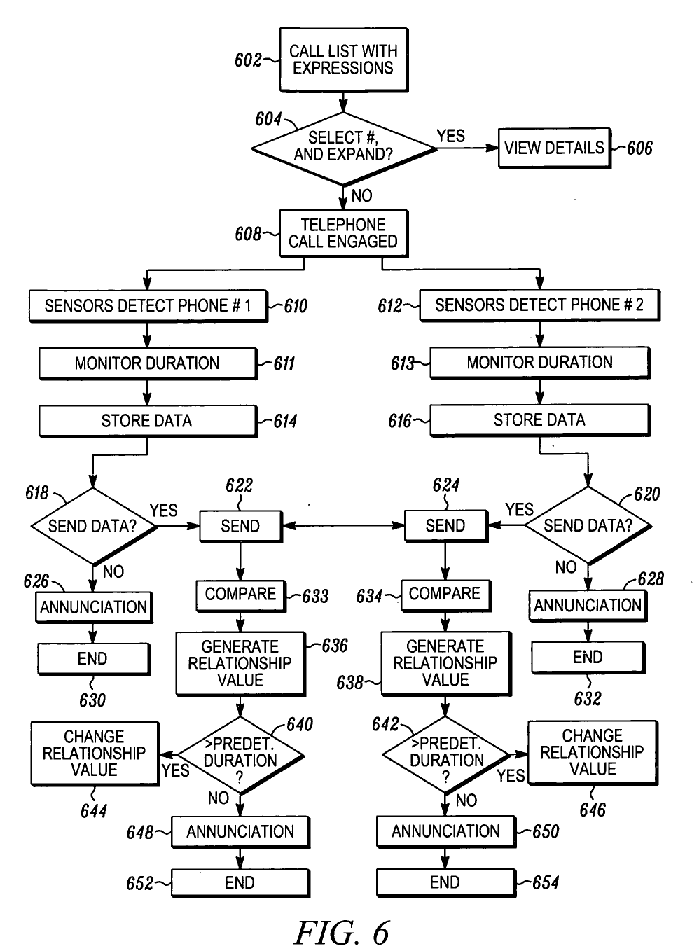

The first embodiment above will have a larger file size than the second and third embodiments. It may take more processing power to compare two of these files since the timestamps need to be converted to a normalized timeline. In the second and third embodiment, the duration will be computed before saving it to the log file. The third embodiment requires less processing power for comparisons as described below in conjunction with FIG. 6.

FIG. 3 depicts some examples of expression codes 302 correlated with expressions 304 and visual representations 306 thereof. For example, the expression code 1, angry, can be visualized by an angry face. The expression code 2, happy/excited can be visualized by a happy face, and so on. The images can then be used to provide memory triggers to help the user remember key contextual details about past conversations. Also, the visual and/or audio representation in real time can provide feedback to the user in real time about how he or she was perceived during communication with another user.

Instructions, either installed in the communication device or downloaded, correlate an expression signal sensed as described above with an expression code. The code, correlated to the signal, results in the annunciation of certain visual representations displayed on the screen of the communication device meant to depict the expression sensed. Other forms of representations meant to depict expression attributes sensed can also be provided. For example, the communication device can output an audible sound that correlates with an expression sensed.

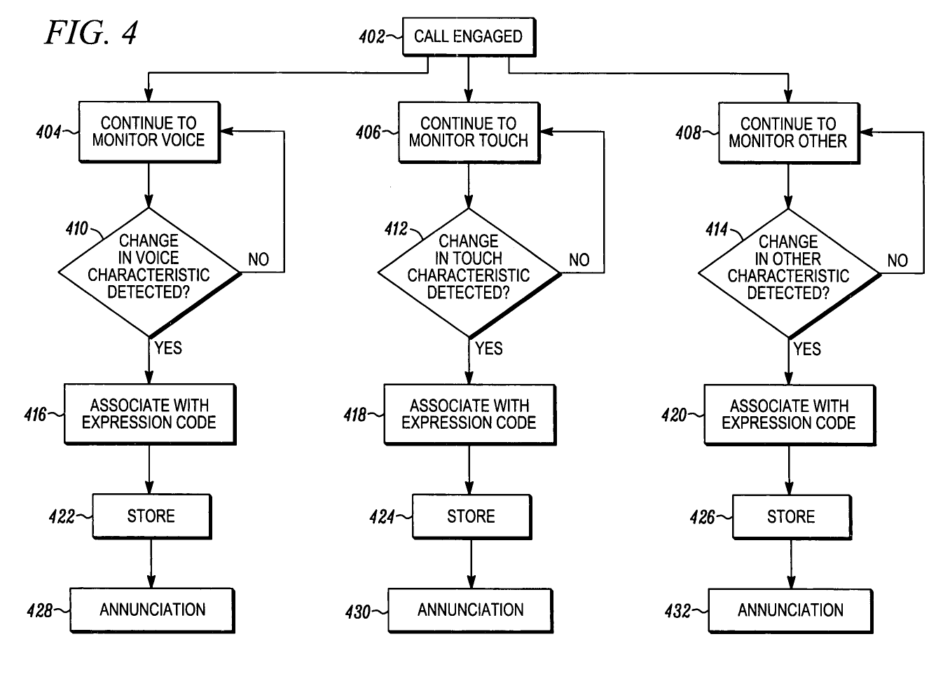

When the communication device 100 senses that a user's expression changes from one state to a different state, the associated expression code will be logged in a file. FIG. 4 is a flow chart of the sensors of two communication devices generating signals and the associated expression codes being stored. When communication is engaged between two or more devices, including land lines, telephones, cellular telephones, Internet telephones, cordless telephones, walkie-talkies 402 and the like, the sensors monitor voice, touch and other expression characteristics at 404, 406 and 408. As change is detected at 410, 412 and 414, expression codes are associated at 416, 418 and 420. The expression codes are stored at 422, 424 and 426 and a representation of the expression code is annunciated 428, 430 and 432 on display device 122. It will be appreciated by those of ordinary skill in the art, if the user wishes to monitor changes in expression in real time but not make a log, the storing step can be eliminated. For example, when engaging in an Internet call, expression images can appear on a computer screen while the user is engaged in a conversation. Therefore, during the call in real time and/or at the end of communication, the generated list of expressions codes can be provided, as well as their visual or audio representations.

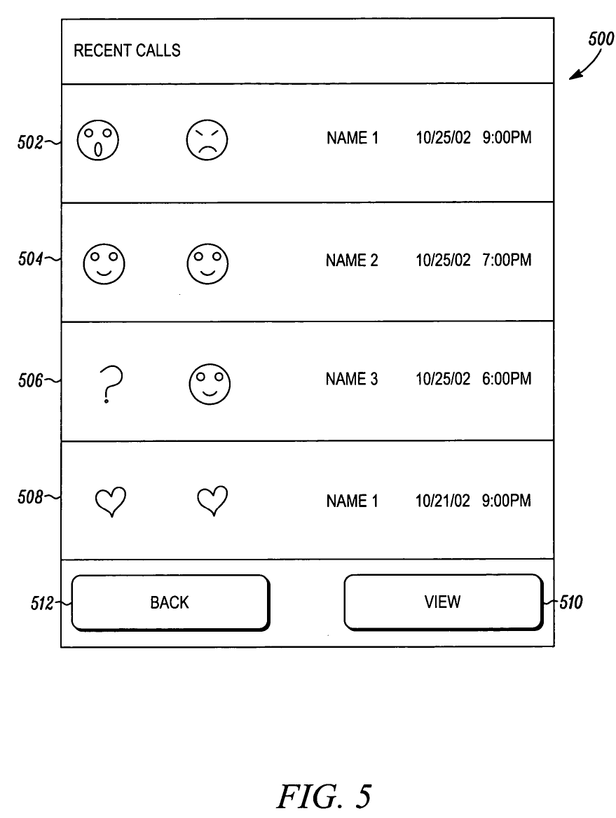

FIG. 5 depicts an example of visual representation of expression codes that in a file log format. The expression codes can be stored in the communication device memory. The expression code is annunciated by a representation, and as in this example, a particular image. The file log is configured for display as in file log 500. In this example, a list of communication events that have been made on a particular communication device is shown. The entries in the Recent Calls List of this example include two images. A first image on the left represents the user's expressions during the call. The image on the right represents the other party's expression during the call. To minimize processor consumption, the more dominant expressions can be shown in this view. The dominant expressions can be extracted from the log file by selecting the expression codes that are most prevalent (perhaps the top three expressions during a conversation). If the user would like a detailed visual summary, the user chooses, for example “view” from the view button 510 shown in FIG. 5, or “details” from a drop down menu (not shown), to see more or all of the expressions contained in the file log. The file log can further contain information such as time stamps shown on the far right side of logs 502, 504, 506 and 508 and duration of the expression, as well. The recent call list including visual representations and the file log can be in any configuration, or can be suppressed until the user activates either one or both.

Still referring to FIG. 5, the first row 502 summarizes a communication with a party denoted NAME1. In this row, the two visual representations are of expression code 5, scared and expression code 1, angry (see FIG. 3). As can be seen in FIG. 5, the visual representations show disagreement in the communicator's expressions which may help trigger a user's recall of the conversation. Rows 504, 506 and 508 depict visual representations of other communication events.

The list represented in FIG. 5 provides an indication of the mood or interaction between the parties to the communication. For example, it can indicate that the users were upset. It can also indicate that one person spoke more than the other or that there were arguments. Also, the conversation may have included one or more long intervals of dead silence or a great deal of active participation. The categorization of communication attributes by imagery provides information in a stimulating way to help the user to remember the context of the conversation and provide memory triggers. The automatic sensing and encoding of sensor signals used in addition to any manual input the user provides assists in user recall of conversation content and/or expression.

In the event that the user wishes to view more of the file log, the user can highlight row 502 and then click “view” 510 to see more information. Then to return to the top level view, the user clicks “back” 512. The entire file log can be available, or particular parts based on duration, or other criteria can be viewed instead.

Another option for technology described herein, is to record communications, and replay the communication while the file log is displayed through the conversation. The uses for such a configuration include that the user requiring the ability will be able to revisit important moments in a conversation, and learn how the sensors interpret both the user's communication, and also that of another party to the communication.

In general, the list of calls with expression codes as shown in FIG. 5 can be displayed on the display of the communication device 100. Turning to FIG. 6, there is a flow chart of communication that can occur between two or more parties, the first party on a first communication device 100, the second party on second communication as indicated in FIG. 6 as 612. The second device can be configured with at least one sensor, and can operate as does communication device 100 which has been described in detail above. The representation of the expression code of the second device 612 can be stored in the first device memory 124 and can be configured as part of the call list of the first device 500 in at least one of two ways. First, the second device 612 may transmit a copy of its expression codes and associated representation to the first communication device 100. Also, or instead, the first device may sense characteristics from the call signal it receives from the second device during a call.

In this example, a representation of conversations of two devices is configured on the call list of the first communication device 100. The first user views a display 602 like 500 shown in FIG. 5. The user can select a telephone number to call by highlighting a row 604 in FIG. 5 and pressing SEND on a communication device or by dialing the number on the keypad. As shown in FIG. 5, the user can “view” details of one or more previous calls 606. The user can then engage the call 608. As mentioned above, if more than one electronic units of the call have sensors, they can be activated to detect changes in expression 610 and 612. The time for a time stamp and duration of a communication or a portion of a communication can be monitored at 611 and 613. Specifically, the duration of the period of time an expression code is generated can be compared as described below. The sensor signal data is processed as shown in FIG. 4 at 416, 418 and 420, and stored 422, 424 and 426. FIG. 6 similarly shows data collected 610 and 612 and stored at 614 and 616. If the send option is available 618, and 620, the log file can be sent via Short Message Service (SMS) message. The expression codes can then be translated to a visual representation. Accordingly, a user can send the data 622 and 624 stored at step 614 and 616. The expression codes can be sent throughout the communication or at the communication's end. However, the send option may be suppressed. If so, the data is not sent, Representations can be annunciated at 626 and 628 and the process can end at 630 and 632.

A representation, such as a visual indication of both parties' expressions during the conversation provides valuable memory triggers to help the user remember the context of the conversation. The user can then better plan for events and remembers important tasks to complete. Still referring to FIG. 6, more information can be provided to the users. For example, information such as relationship values to gauge the difference in the expression codes can be provided. The relationship values can gauge a conversation as a whole and/or parts of the conversation.

Since the expression codes can be of varying magnitudes, the processor of the first and second device can compare 633 and 634 expression codes and provide a numerical relationship value 636 and 638 of the comparison. The comparison may be annunciated by a relationship value representation in a similar fashion to that of the expression codes, or may be annunciated by indicating the magnitude of the difference in the expression codes. For example, if one party is speaking loudly, or shouting, and the other party is silent or crying, the relationship values can be substantially different. As described above, the expression codes may include ranges, such as 10 or 100 in value. If the expression codes for angry speech are 50-60, and the number here is 55 and the expression codes for silence is 10-20 and the number here is 15, then the comparison steps 625 and 627 may be −35 and 35 respectively. A numerical code for the relationship value itself can be annunciated and/or a representation can be provided. In this way, further information about the conversation can be provided to one or more users.

A discussed above, the duration of a communication or a part of a communication is monitored at 611 and 613. Comparative information relating to the duration and the relationship value can also provide important data about the conversation to the user. The step of retrieving duration value of a communication and determining whether it reaches or exceeds a threshold duration value to accordingly change a corresponding relationship representation is performed at step 640 and 642. If the predetermined threshold value is reached or exceeded, the corresponding relationship value is changed 644 and 646. The value to which the relationship value changes according to duration may be stored in table or calculated according to an algorithm. A log file such as that shown in FIG. 5 may provide an annunciation 648 and 650 of the results of the steps in FIG. 6. The process can end 652 and 654.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method within a communication device for representing characteristics of a communication between the communication device and a second device, wherein the communication device includes at least one sensor, the method comprising the steps of:
monitoring the communication using at least one sensor to generate a sensor signal;
correlating the sensor signal with a first expression code; and
annunciating a first representation of the first expression code.

2. A method as recited in claim 1, further comprising the step of:
storing the first expression code in the communication device;

3. A method as recited in claim 2, wherein the storing step comprises:
adding the first expression code to a log file.

4. A method as recited in claim 2, wherein the storing step comprises:
adding the first expression code to a log file with a time stamp.

5. A method as recited in claim 1, wherein the communication device further includes a display device, and wherein the first representation is a first visual representation, and further wherein the annunciating step comprises displaying on the display device the first visual representation.

6. A method as recited in claim 5, wherein the storing step comprises:
adding the first expression code to a log file,
the method further comprising the step of:
displaying the log file to include the first visual representation.

7. A method as recited in claim 1, wherein the annunciating step comprises one or more annunciating methods selected from a group comprising playing an audible first representation, illuminating a light first representation, activating a haptic first representation, displaying a visual first representation, and highlighting one or more portions of the communication using a color representation.

8. A method as recited in claim 1, wherein the second device includes at least one second device sensor, the method further comprising prior to the annunciating step, the steps of:
receiving a second expression code from the second device, wherein the second expression code is generated at the second device using at least one second device sensor; and
annunciating a second representation of the second expression code along with the first representation of the first expression code.

9. A method as recited in claim 8, further comprising the step of:
storing the second expression code in the communication device.

10. A method as recited in claim 9, wherein storing step comprises:
adding the second expression code to a log file.

11. A method as recited in claim 9, wherein the storing step comprises:
adding the second expression code to a log file with a time stamp.

12. A method as recited in claim 8, wherein the communication device further includes a display device, and wherein the first representation is a first visual representation and the second representation is a second visual representation, and further wherein the annunciating step comprises displaying on the display device the first visual representation and the second visual representation.

13. A method as recited in claim 8, wherein the annunciating step comprises one or more annunciating methods selected from a group comprising playing an audible first representation, playing an audible second representation, illuminating a light first representation, illuminating a light second representation, activating a haptic first representation, activating a haptic second representation, displaying a visual first representation, displaying a visual second representation, and highlighting one or more portions of the communication using a color representation.

14. A method as recited in claim 12, further comprising:
displaying the log file to include the second visual representation.

15. A method as recited in claim 8, further comprising the steps of:
comparing the first expression code and the second expression code; and
annunciating a relationship representation in response to the comparing step, wherein the relationship representation comprises one or more representations selected from a group comprising an audible representation, a light representation, a haptic representation, a visual representation, an animation representation, and a communication highlighting representation.

16. A method as recited in claim 15, further comprising the steps of:
tracking a duration of the communication; and
changing the relationship representation when the duration matches a predetermined duration.

17. A method as recited in claim 8, further comprising prior to the annunciating step, the steps of:
associating the first expression code and the second expression code with the communication,
wherein the annunciating step comprises annunciating the first representation, the second representation, and a communication representation.

18. A method as recited in claim 17, wherein the communication device further includes a display device, and wherein the first representation is a first visual representation, wherein the second representation is a second visual representation, wherein the communication representation is a visual communication representation, and further wherein the annunciating step comprises displaying on the display device the first visual representation, the second visual representation, and the visual communication representation.

19. A method as recited in claim 17, wherein the annunciating step comprises one or more annunciating methods selected from a group comprising playing an audible first representation, playing an audible second representation, playing an audible communication representation, illuminating a light first representation, illuminating a light second representation, illuminating a light communication representation, activating a haptic first representation, activating a haptic second representation, activating a haptic communication representation, displaying a visual first representation, displaying a visual second representation, displaying a visual communication representation, and highlighting one or more portions of the communication using a color representation.

20. A method as recited in claim 1, further comprising the step of:
transmitting the first expression code to the second device.

21. A method as recited in claim 1 wherein generating a sensor signal, comprises:
sensing voice fluctuations; and
generating a voice sensor signal.

22. A method as recited in claim 1 wherein generating a sensor signal comprises:
sensing touch fluctuations; and
generating a touch sensor signal

23. A method as recited in claim 1 wherein generating a sensor signal comprises;
sensing hand temperature fluctuations; and
generating a hand heat sensor signal.

24. A method as recited in claim 1 further comprising the steps of:
generating a plurality of sensor signals associated with the communication;
associating the plurality of sensor signals with a plurality of expression codes;
storing the plurality of expression codes in the communication device; and
displaying a plurality of visual representations of the expression codes associated with the communication.

25. A method for operating a communication device including sensors to store a collection of expression codes associated with visual representations, comprising:
processing instructions for transmitting a request to receive expression codes and visual representations;
transmitting the request;
receiving the expression codes and the visual representations;
assigning the expression codes to the visual representations;
storing the expression codes and the visual representations in the communication device.

26. A method as recited in claim 25, further comprising the step of:
associating a characteristic with an expression code wherein the characteristic is one or more chosen from a group comprising a voice characteristic, a touch characteristic, and a heat characteristic.

27. A method as recited in claim 25 further comprising the step of:
accessing the expression codes when the communication device is engaged in communication.

28. A method as recited in claim 27 further comprising the steps of:
generating a plurality of sensor signals;
correlating the plurality of sensor signals with the expression codes;
storing the expression codes in the communication device; and
displaying visual representations of the expression codes associated with the communication.

29. A method as recited in claim 28 further comprising the step of:
transmitting at least one stored expression code to another communication device.

30. A communication device, comprising:
at least one sensor adapted to monitor expression and generate a first expression signal;
a processor adapted to associate the first expression signal with an expression code;
a memory adapted to store the expression code associated with the first expression signal; and
a display adapted to display a representation of the expression code.

31. A communication device as recited in claim 30, further comprising:
a communication receiver adapted to receive a communication signal;
at least one communication sensor adapted to monitor the communication signal and generate a second expression signal;
a processor adapted to associate the second expression signal with a second expression code;
a memory adapted to store the second expression code associated with the second expression signal;
a display adapted to display a representation of the second expression code.

32. A communication device as recited in claim 31, further comprising:
instructions to generate a time stamped log file of first expression codes correlated with a call list.

33. A communication device as recited in claim 31, further comprising:
instructions to generate a time stamped log file of second expression codes correlated with a call list.

34. A communication device as recited in claim 27 wherein the communication device is selected from a group comprising a cellular telephone, a mobile telephone, a cordless telephone, a wired telephone, a messaging device, a personal digital assistant, and a personal computer.
